(19) United States
(12) Patent Application Publication
(10) Pub. No.: US 2010/0325024 A1
(43) Pub. Date: Dec. 23, 2010

(54) System and Method for Obligation Management in Wireless Communication Devices

(76) Inventors: William P. Alberth, JR., Prairie Grove, IL (US); William Hede, Lake in the Hills, IL (US); Scott Steele, San Diego, CA (US)

Correspondence Address: PHILIP H. BURRUS, IV, 460 Grant Street, Atlanta, GA, 30312, US

(21) Appl. No.: 12/489,312

(22) Filed: Jun. 22, 2009

(51) Int. Cl. G06Q 30/00; G06Q 50/00

(52) U.S. Cl. 705/34

(57) ABSTRACT

A wireless communication device (100) includes an obligation manager (101) that is configured to cause a processor (102) operable with a memory (103) to determine which member of a group is to be responsible for fulfillment of a group obligation. The obligation manager (101) determines which member will fulfill the obligation by comparing the current obligation to an obligation register (300) having fulfillment entries (301,302,303) indicating past obligations and members fulfilling those obligations.

### BACKGROUND

1. Technical Field

This invention relates generally to wireless communication devices, and more particularly to an obligation management system and corresponding method suitable for use with wireless communication devices.

2. Background Art

People enjoy socializing. Groups of friends routinely get together to exchange stories, catch up on each other's lives, and generally enjoy the companionship of congenial friends. For example, it is not uncommon for a group of friends to get together in a restaurant once a week to share stories and a meal.

A problem associated with such outings occurs when the bill arrives. Dividing the bill can be troublesome. It can be almost impossible without the assistance of a calculator. One friend will have soup and a salad only, while another friend enjoys the four-course chef's tasting menu, complete with wine pairings. Even if the group successfully divides the bill, payment of each person's share can still be problematic. One friend has no cash and wants to pay by credit card, while another only has travelers cheques. Seldom will a member of the group have exact change. For instance, a member with a small tab might not have anything smaller than a $100 bill, thereby requiring change.

To solve this problem, one friend in the group might decide to pick up the tab one week, allowing another to pick up the tab the next week. This process works well, provided that the members can remember who paid when. Remembering the details week to week can be difficult. This difficulty can be further compounded when the group changes venue from week to week. A friend picking up the tab at a restaurant having two Michelin® stars one week may not feel fully remunerated when another friend picks up the tab at a burger joint the next week.

There is thus a need for a system and method of tracking obligations undertaken and fulfilled by members of a group.

### BRIEF DESCRIPTION OF THE DRAWINGS

FIG. 1 illustrates a wireless communication device in accordance with embodiments of the invention.

FIG. 2 illustrates one method of managing obligations in accordance with embodiments of the invention.

FIG. 3 illustrates one embodiment of an obligation register in accordance with embodiments of the invention.

FIG. 4 illustrates one method of negotiating fulfillment of obligations in accordance with embodiments of the invention.

FIG. 5 illustrates one exemplary use case for recording obligations in an obligation register in accordance with embodiments of the invention.

FIG. 6 illustrates a method corresponding with FIG. 5.

Skilled artisans will appreciate that elements in the figures are illustrated for simplicity and clarity and have not necessarily been drawn to scale. For example, the dimensions of some of the elements in the figures may be exaggerated relative to other elements to help to improve understanding of embodiments of the present invention.

### DETAILED DESCRIPTION OF THE INVENTION

Before describing in detail embodiments that are in accordance with the present invention, it should be observed that the embodiments reside primarily in combinations of method steps and apparatus components related to tracking obligations incurred by a group and determining which member or members will fulfill a current obligation based upon an obligation fulfillment history. Embodiments of the invention are operable with electronic devices, such as wireless communication devices. Embodiments of the invention work in conjunction with data and files stored in computer readable media. The method steps described herein can thus be used to transform memory states of storage devices and computer readable media by transforming gates, switches, and storage devices, and therefore the physical state of the data and files, from a first state to a different second state.

It will be appreciated that embodiments of the invention described herein may be comprised of one or more conventional processors, computer readable media, and unique stored program instructions that control the one or more processors to implement, in conjunction with certain non-processor circuits, some, most, or all of the functions of managing obligations and determining which member or members of a group will fulfill a new obligation as described herein. The non-processor circuits may include, but are not limited to, a radio receiver, a radio transmitter, signal drivers, clock circuits, power source circuits, and user input devices. The computer readable media can include electromagnetic storage, optical storage, or other data storage devices. As such, the functions described herein may be interpreted as steps of a method to perform obligation management in a wireless communication device. Alternatively, some or all functions could be implemented by a state machine that has no stored program instructions, or in one or more application specific integrated circuits, in which each function or some combinations of certain of the functions are implemented as custom logic. Of course, a combination of the two approaches could be used. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and circuits with minimal experimentation.

Embodiments of the invention are now described in detail. Referring to the drawings, like numbers indicate like parts throughout the views. As used in the description herein and throughout the claims, the following terms take the meanings explicitly associated herein, unless the context clearly dictates otherwise: the meaning of “a,” “an,” and “the” includes plural reference, the meaning of “in” includes “in” and “on.” Relational terms such as first and second, top and bottom, and the like may be used solely to distinguish one entity or action from another entity or action without necessarily requiring or implying any actual such relationship or order between such entities or actions. Also, reference designators shown herein in parenthesis indicate components shown in a figure other than the one in discussion. For example, talking about a device (10) while discussing figure A would refer to an element, 10, shown in figure other than figure A.

Embodiments of the present invention provide a method and system in a wireless communication device for tracking and sharing obligations incurred by a group. For example, where a group routinely goes to lunch at restaurants only accepting cash, embodiments of the invention provide systems and methods for tracking which member or members of the group pays the bill. As such, embodiments of the invention can assist in selecting the next person to pay based upon the group's obligation fulfillment history.

In one embodiment, the system and method determines who is a member of the group. The system and method then tracks who fulfills obligations of the group and when those obligations are fulfilled. The system and method then maintains a virtual “obligations due” account, which can be stored on one or more wireless communication devices belonging to the members or alternatively on a remote server or computer.

When the group undertakes an obligation, such as going to another group lunch, the system and method compares the obligation to an obligation register containing an obligation fulfillment history corresponding to the group. The system and method then determines which member or members should fulfill the current obligation. For example, in one embodiment, the system and method can consider who paid the lunch tab most recently, or which member has not fulfilled the group obligation for the longest period of time. Alternatively, in another embodiment, the system and method can consider which member of the group “owes” the most to other members of the group.

Embodiments of the invention are not limited to monetary transactions. Other types of obligations can also be monitored. For example, if members of a group frequently barter, the system and method can track these barter transactions. Similarly, if members of a group routinely have “covered dish suppers” at each others' homes, the system and method can track obligations such as which members home should be used next or which member should be responsible for the entree.

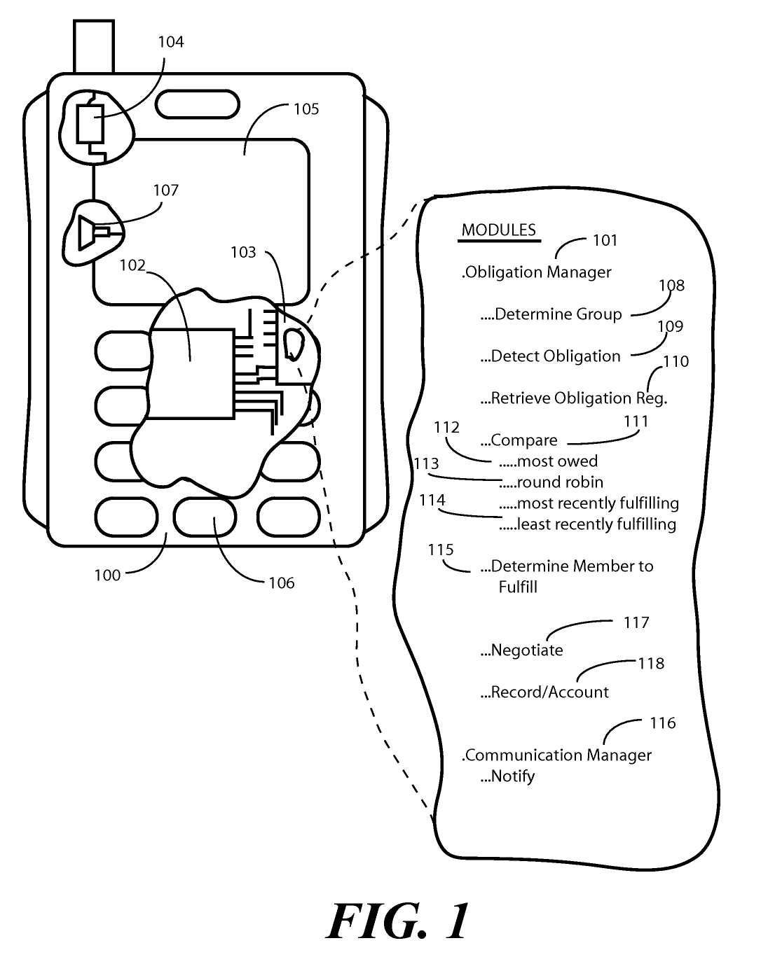

Turning now to FIG. 1, illustrated therein is one embodiment of a wireless communication device 100 having an obligation manager 101 in accordance with embodiments of the invention. The obligation manager 101 is configured to track obligations corresponding to a group and to determine which one or more of the members of the group will fulfill a given obligation incurred by the group.

The wireless communication device 100 may be a mobile wireless handset, such as a mobile telephone. For example, the wireless communication device 100 may be a CDMA, GSM/GPRS, or some other type of mobile communications device. While a mobile telephone is shown in the illustrative embodiment of FIG. 1, it will be clear to those of ordinary skill in the art having the benefit of this disclosure that the invention is not so limited. The obligation manager 101 of embodiments of the present invention could also be operable with other wireless communication devices, including portable digital assistants, palmtop computers, gaming devices, “netbooks,” multimedia devices, and so forth.

In the illustrative embodiment of FIG. 1, the exemplary wireless communication device 100 includes generally a processor 102 coupled to a memory 103 or other computer readable medium. The processor 102 can be a single processor, such as a microprocessor integrated circuit, or alternatively may comprise one or more processing units or components. The processor 102 can be either a programmable processor, an application-specific integrated circuit for performing tasks such as maintaining and processing obligation information and managing an obligation register stored in the memory 103, or combinations thereof.

The processor 102 can include other processing units dedicated to performance of specific functions. For example, an integrated or stand-alone digital signal processor (DSP) may handle the processing of incoming signals or data. In the illustrative embodiment of FIG. 1, the processor 102 is illustrated for simplicity as an integrated circuit, but shall be understood to be representative of any processing architecture known to those skilled in the art.

In one embodiment, the processor 102 executes code comprising one or more routines stored either in the memory 103, which may comprise one or more memories. The memory 103 may comprise a separate and distinct integrated circuit connected and operable with the processor via a data bus (not shown). The memory 103 may include one or more read-only memories, dynamic or static random-access memory, or any other type of programmable memory, such as one or more EPROMs, EEPROMs, registers, and the like. In some embodiments, the memory 103 can comprise non-traditional storage devices, such as a SIM, USIM, R-UIM, NVM, etc. The routines stored in the memory 103 can be stored in the form of executable software, firmware, or in any other fashion known to those skilled in the art. The processor 102 is configured to execute instructions stored in the memory 103 to provide the functionality of the wireless communication device 100.

In addition to the executable code operable with the processor 102, the memory 103 may further store information received from another device via the wireless communication circuit 104, or information generated by the user through the user input 106. The information from the other devices may include identification of the members of a group, information regarding obligations undertaken, and so forth.

The processor 102 is also coupled to and operable with a wireless communication circuit 104, such as the radio transceiver shown in FIG. 1. Data is exchanged with other devices and networks via the wireless communication circuit 104. Note that the wireless communication circuit 104 can include wide area network communication circuits, local area network communication circuits, or combinations thereof. For example, in one embodiment, the wireless communication circuit 104 includes a local area network communication, such as a Bluetooth® circuit, that is capable of detecting the presence of other devices within the local area network.

The processor 102 is additionally operable with a user interface, which can include a display and user input 106. One example of a user input 106 is the keypad shown in FIG. 1. Other user interfaces may also be used, including touch sensitive displays and voice-actuated controls. The user interface may also include a microphone or data port. User output devices 107 may also be provided, such as a speaker or data ports.

In one embodiment, the wireless communication device 100 includes an obligation manager 101, which may be configured as executable code and stored in the memory 103. Alternatively, it can be configured in hardware as programmable logic. The obligation manager 101 is operable with the processor 102 and is configured to track a plurality of obligations incurred by one or more groups. Further, the obligation manager 101 is configured to keep an accounting of the members of the group that fulfill those obligations, so as to assist a user in determining which member or members should fulfill a current obligation. The obligations can take many forms, including billed amounts for goods, quantities and types of goods or services received by a group, information corresponding to barter transactions, and so forth.

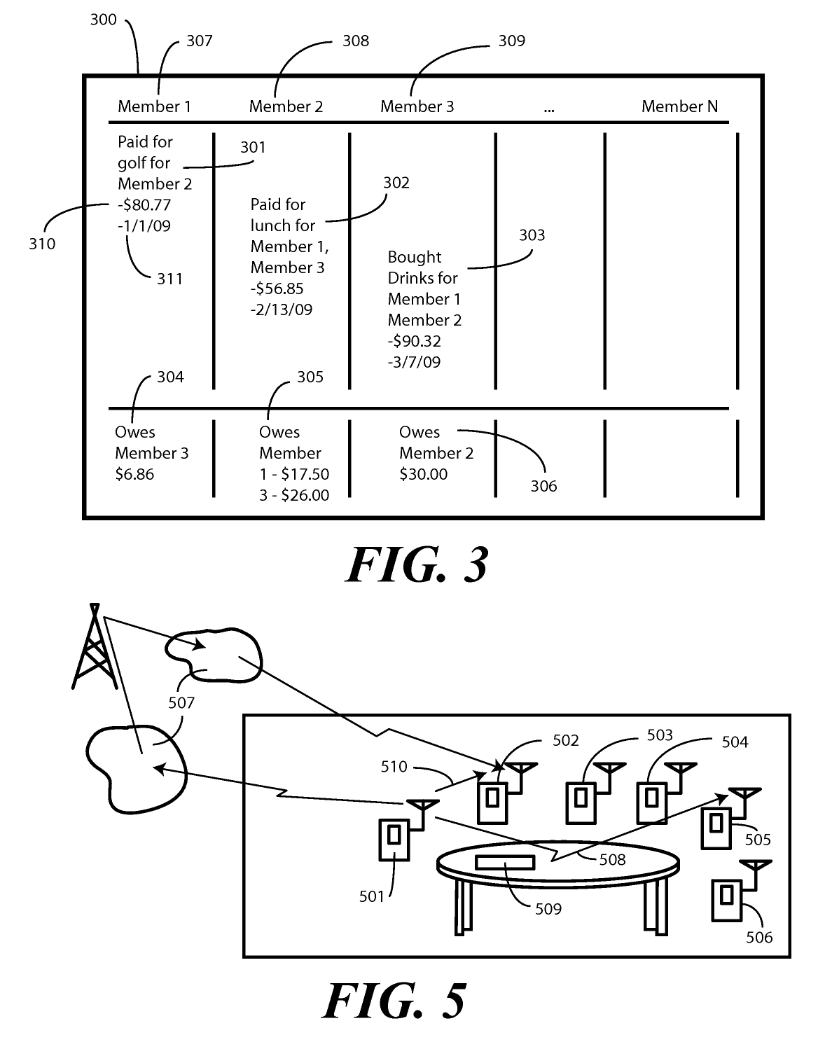

As will be shown in more detail in FIG. 3, the obligation manager 101 can store various types of information relating to obligations in an obligation register. For example, the obligation manager 101 can track the value of the obligation, the portion of the obligation incurred by each member, the number of members incurring the obligation, the date the obligation was incurred, the date the obligation was fulfilled, and so forth. When a future obligation is incurred, the obligation manager can retrieve the obligation register from memory, which may be the memory 103 in the wireless communication device or a remote memory, such as a server in communication with the wireless communication device 100 via a network. By comparing the obligation register with the current obligation, the obligation manager 101 can determine one or more members to be responsible for the obligation. This is more easily understood with the use of an example.

Consider the situation where members of a group gather for lunch. The obligation manager 101 is initially configured to determine 108 which members of the group are present. This can be done in a variety of ways. In one simple embodiment, the user of the wireless communication device 100 having the obligation manager 101 operable therewith may enter information identifying the members present from the user interface 106. The user may type the member's names in or, alternatively, select the members from an address book, contact list, or other list of people stored in the memory 103. In another embodiment, such as where each member of the group has a wireless communication device, the obligation manager of the wireless communication device 100 can be configured to automatically detect the presence of the other devices through a local area communication network such as Bluetooth® or wide area communication network as is known in the art.

Once the members of the group are known, the user, in one embodiment, can configure how the obligation manager 101 selects the member or members who will be responsible for future obligations via the user interface 106. For example, the user may program the obligation manager 101 to select the member fulfilling the obligation on a round-robin basis. Alternatively, the user may program the obligation manager 101 to select the member fulfilling the obligation based upon which member has gone the longest without fulfilling a group obligation. Similarly, the user may program the obligation manager 101 to select the member fulfilling the obligation so as to reduce the largest amount owed to another member. In one embodiment, the user can defer to the obligation manager 101 to select the member fulfilling the obligation on an optimized basis. It will be clear to those of ordinary skill in the art having the benefit of this disclosure that the invention is not so limited. Other means for selecting the member to fulfill the obligation can also be used.

The obligation manager 101 determines 109 that a current obligation is due. In one embodiment, this can be done by receiving data via the wireless communication circuit 104. For instance, a merchant can transmit an amount due from a computer or cash register having wireless communication capabilities. In another embodiment, the user may input the details of the obligation via the user interface 106. The obligation manager 101 may then optionally notify the members of the group of the obligation. This notification can be done directly, such as through a local area network communication circuit. Alternatively, this can be done through a wide area network communication circuit, such as via an instant message or text message.

Once the debt is determined, in one embodiment, the obligation manager 101 retrieves 110 an obligation register (one example of which is shown in FIG. 3) from a memory. The memory storing the obligation register may be the memory 103 in the wireless communication device or a remote memory, such as a server in communication with the wireless communication device 100 via a network. In one embodiment, the obligation register includes a plurality of past obligations, as well as information regarding which members of the group were responsible for fulfilling those obligations.

Once retrieved, the obligation manager 101 compares 111 the obligation due with the obligation register to determine 115 which members of the group should be responsible for fulfilling the current obligation. As noted above, this can be done in a variety of ways, including by largest amount owed 112, round robin 113, most recently or least recently fulfilling an obligation 114, and so forth. Continuing with the lunch example above, the obligation manager may consider which member of the group has least recently paid for lunch for the group, and may select that member to pay for the current lunch tab.

A communication module 116, operable with the processor 102 and the wireless communication circuit 104, can then be configured to notify the one or more members to fulfill the obligation for the group. For instance, the communication module 116 may transmit a text message to the members informing them that it is their turn to pay for lunch. Alternatively, the communication module 116 may directly transmit a data file to obligation managers of other devices indicating the results of the fulfillment determination process so that the other members' devices can likewise be updated.

The obligation manager 101 then performs an accounting 117 by updating the obligation register in accordance with the member selection. In one embodiment, the obligation manager is configured to complete this task by recording an obligation due for the members not fulfilling the current obligation, and by subtracting an amount due by the members fulfilling the current obligation from a value owed by the one or more members fulfilling the current obligation.

Using a simple example, consider the situation when Tom, Fred, and George go to lunch. If the tab is $12, and George pays, the obligation manager 101 may record an obligation due by Fred and George of $4 each. When the three go to lunch the next time, and the tab is $15, and Tom pays, the obligation manager 101 can record this fulfillment such that George now has an obligation due of $1, while Fred has an obligation due of $9.

Embodiments of the invention can be used to itemize obligations due by the amount of a debt incurred by members of the group. This is simply performed when the obligation manager 101 determines 109 the obligation is due electronically. The merchant may simply transmit an itemized bill to the obligation manager 101 via the wireless communication circuit 104. Alternatively, the user may enter an itemized bill via the user interface 106.

Using the simple example of Tom, Fred, and George, suppose in the $12 check, Tom is responsible for $2, Fred for $5, and George for $5. When George pays, the obligation manager 101 may record an obligation due by Fred of $5 to George, and another obligation due by Tom to George of $2. Now suppose that in the $15 check, George, Tom, and Fred are each responsible for $5. When Tom pays, the obligation manager 101 can record this fulfillment such that George now has an obligation due of $3 to Tom, while Fred has an obligation due of $5 to Tom and $5 to George.

In one embodiment, an optional negotiation can occur via a negotiation module 118. The negotiation module 118 can be configured to receive one or more offers from the group to fulfill the obligation independent of the selection made by the obligation manager 101. Where this offer is accepted, the obligation manager 101 can, in response, record the accepted offer as a fulfillment in the obligation register.

For instance, even though the obligation manager 101 selects one or more members to fulfill a current obligation, another member may volunteer to pay. By way of example, if the obligation manager 101 selects Tom to pay, and its Tom's birthday, George may elect to pay for Tom. The obligation manager 101 can be configured to account for this in a variety of ways. In one embodiment, this can be considered a gratis gift of George, which would not cause Tom to incur an obligation due. Alternatively, Tom may want to pay for George on his birthday, and so this particular transaction can be accounted accordingly. Additionally, one member may want to “square up” with the group. In such a situation, the negotiation module 118 may relay an offer from that member to clear all obligations due. The obligation manager may then compute a total amount due by that member, and may inform that member of this amount.

There may be some situations in which a method of selection has been configured by the user that results in a tie. For instance, a user may configure the obligation manager 101 to select a member to fulfill an obligation by determining which member has gone the longest without fulfilling an obligation. It is possible that a tie will result. In one embodiment, the obligation manager is configured to break ties by random choice.

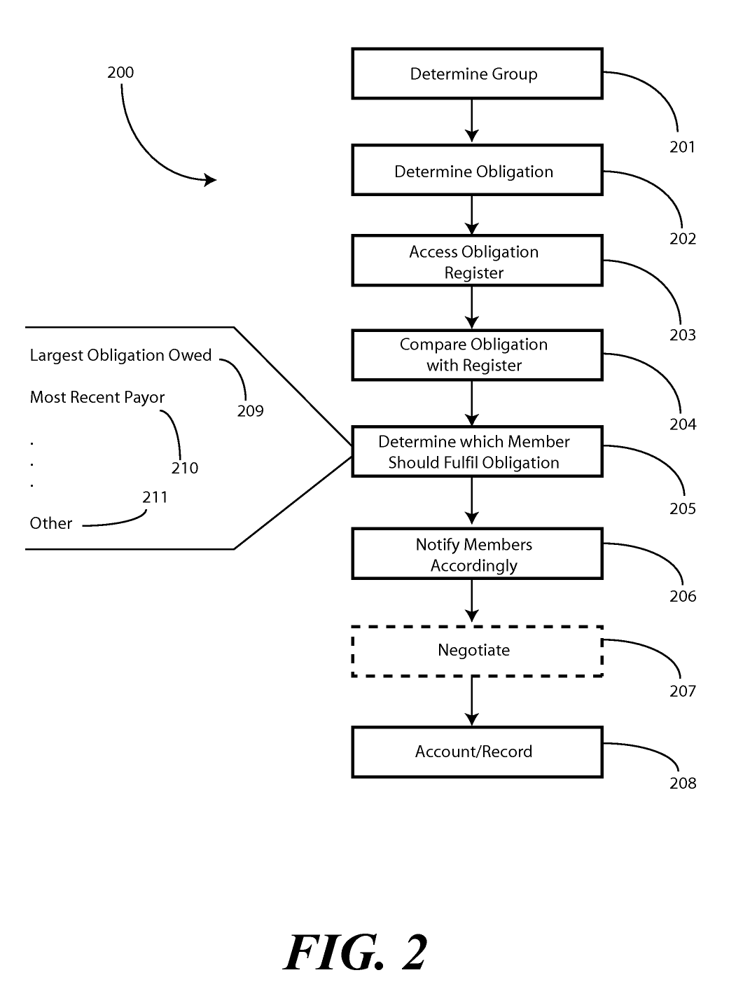

Turning now to FIG. 2, illustrated therein is a method 200, suitable for deployment in a wireless communication device (100) as executable code stored in a computer readable medium, for determining which one or more members of a group should fulfill an obligation incurred by two or more members of the group in accordance with embodiments of the invention. The method 200 can be stored in the computer readable medium as instructions for execution on a processor (102) to determine which members should fulfill the current obligation.

At step 201, the method 200 determines the members of the group. As noted above, this step 201 can be accomplished in several ways. The user may employ a user interface (106) to enter the members of a group, such as selecting members from an address book. Alternatively, the method 200 may determine the members electronically, such as through a local or wide area network wireless communication circuit.

Note as well that the method can be used for multiple groups. For example, a particular user may play golf with one group, go to business lunches with another group, and go to movies with yet another group. Members of these groups can overlap. As such, one person may be a member of two groups. Tom, for example, may be a member of the “golf group” and the “lunch group.”

At step 202, the method 200 determines that an obligation is due. In one embodiment, this determination is accomplished by receiving data through the wireless communication circuit (104). In another embodiment, the user may manually enter data relating to the obligation through the user interface (106). At this step 202, the method 200 may further determine a portion of the obligation that is attributable to each of the members where itemized accounting is desired.

Upon detecting the obligation at step 202, the method 200 accesses an obligation register from a memory device at step 203. In one embodiment, the obligation register includes an accounting of at least one member fulfilling at least one past obligation. For example, the accounting for the “lunch group” may track dollars spent for lunch, who has paid these dollars for the group, and amounts owed to or from each member of the group. Similarly, the “golf group” may track rounds of golf paid for by each member, as well as dollars owed from gentlemanly wagering such as the dollar Nassau engaged by the members.

As briefly mentioned above, embodiments of the invention are not limited to monetary transactions. For example, in one embodiment, the method 200 can track obligations owed that result from barter transactions. In these scenarios, the method 200 can be optionally configured to allow a user to set a monetary equivalent or other valuation for the barter or non-monetary transaction.

At step 204, the method 200 compares the obligation register with the current obligation to determine, at step 205, which one or more members of the group should fulfill the obligation that is currently due. As mentioned above, there are a variety of factors that can be used by the method 200 to make this determination. In one embodiment, step 205 includes determining recently fulfilling members 209 who have fulfilled recent obligations of the group. In another embodiment, this step 205 includes determining one or more members who have obligations due 210 that are greater than those owed by other members of the group. Other factors 211 may also be used.

At step 206, the method 200 notifies the one or more members who are to be responsible for fulfillment of the obligation. Alternatively, the method 200 can simply notify each member of the group of the determination of step 205. Optionally, the method 200 can notify the members not responsible for fulfilling the current obligation that the one or more will be responsible for fulfilling the obligation at step 206.

This notification step 206 can occur in a variety of ways. For example, in one embodiment, the method 200 may present the result on the display. Alternatively, the method 200 can transmit a message to the other members via the wireless communication circuit (104) and the communication module (116) indicating the results of the determination. In another embodiment, the method 200 may simply announce the result over a speaker. It will be clear to those of ordinary skill in the art having the benefit of this disclosure that numerous other means of communication between wireless communication devices known in the art can be used, and embodiments of the invention are not to be limited in this respect.

At step 207, negotiation of the selection may occur. In one embodiment, the method 200 receives a negotiation communication from one or more of the members in response to notifying them to fulfill the obligation. For instance, a member may dispute the amount owed. In another scenario, the selected member may have forgotten to bring cash to the event, and accordingly may ask the group's indulgence to pass on this selection and pay the next time. Alternatively, the negotiation communication may be from members other than those selected at step 205. This may be the case in the birthday example described above.

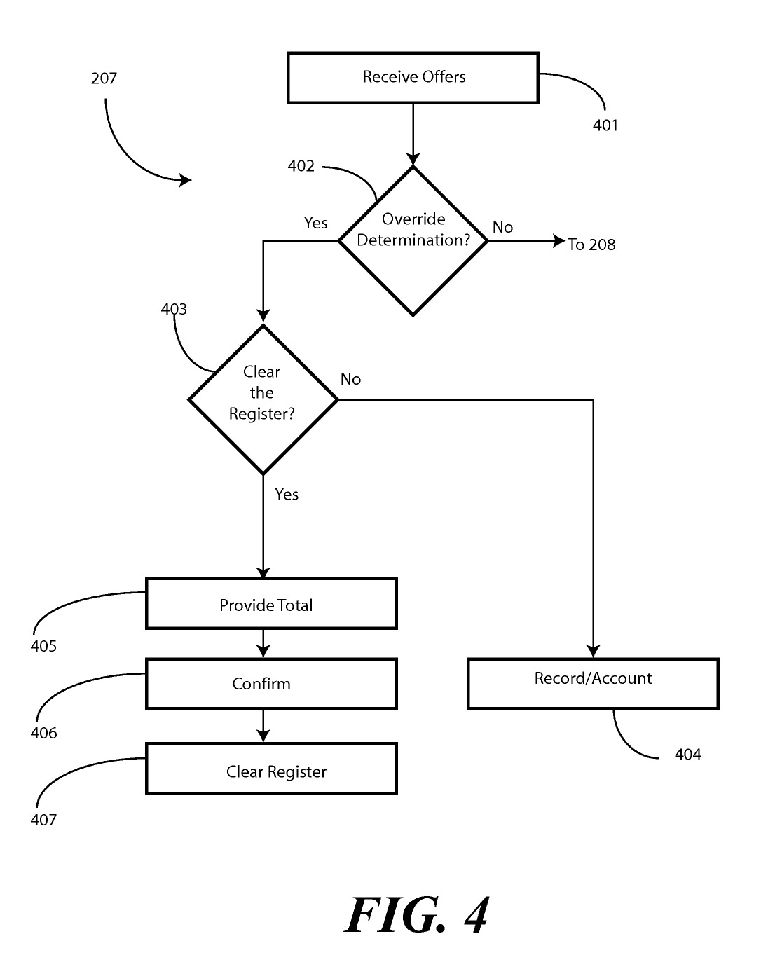

Turning briefly to FIG. 4, illustrated therein is an example of how the negotiation step 207 may be executed. At step 401, the method (200) receives negotiation offers. These negotiation offers can come from members not selected to fulfill the current obligation. In one scenario, the negotiation offer can be a “clear the register” offer in which one particular member wishes to pay for any and all obligations outstanding. In another scenario, a non-selected member may simply be feeling generous and may decide to pay that night. In yet another scenario, a non-selected member may offer to pay for a selected member who forgot his wallet.

At decision 402, the method (200) determines whether to override the selection (made at step 205 of FIG. 2). Where the offer is rejected, the method (200) proceeds to step 208 of FIG. 2.

Where the offer is accepted, the method (200) determines whether the offer is a “clear the register” offer at decision 403. Where it is not, the method (200) accounts for the obligation fulfillment normally at step 404. This accounting, in one embodiment, comprises removing the recording of the fulfillment of the obligation by the one or more selected members in the obligation register and recording another fulfillment of the obligation for the offering member.

Where it is a “clear the register” transaction, the method (200) provides the offering member with a total amount due, or a value corresponding to the obligations owed, at step 405. The method (200) then receives confirmation that the current obligation is fulfilled at step 406.

Turning back to FIG. 2, at step 208 the method 200 accounts for the obligation fulfillment by the selected member. In one embodiment, the method 200 records fulfillment of the obligation in the obligation register. As the obligation register is stored in a memory, this accounting transforms states of switches and data within the memory by application of electric fields and movement of electrons through p-n junctions of semiconductor materials from a first state to a second state. In one embodiment, the method 200 transforms the obligation register to an updated state by recording the obligation and the one or more members fulfilling the obligation in an obligation fulfillment history of the obligation register.

Turning now to FIG. 3, illustrated therein is a graphical representation of one embodiment of an obligation register 300 in accordance with embodiments of the invention. The obligation register 300 is suitable for use with an obligation manager (101) or with a method (200) of determining which one or more members of a group should fulfill a current obligation as described herein.

In one embodiment, the obligation register 300 has stored therein an obligation fulfillment history. The obligation fulfillment history is comprised of a plurality of fulfillment entries 301,302,303. The fulfillment entries 301,302,303 are records of past obligations of the group and identification of members 307,308,309 fulfilling those obligations. Additionally, the obligation register 300 may include obligation entries 304,305,306 that indicate obligations owed to the group or to individual members.

In the illustrative embodiment of FIG. 3, each fulfillment entry 301,302,303 includes a fulfillment value 310 and a fulfillment date 311. It will be clear to those of ordinary skill in the art having the benefit of this disclosure that the invention is not so limited. For example, barter transactions may be classified differently in memory than monetary transactions.

The illustrative embodiment of FIG. 3 shows an obligation register 300 for a group that engages in a variety of activities. One member 307 fulfilled an obligation relating to a round of golf, with which the second member 308 participated, as indicated by fulfillment entry 301. The second member 308 fulfilled an obligation relating to a lunch tab where all three members 307,308,309 were present, as indicated at fulfillment entry 302. A third member 309 fulfilled an obligation relating to a bill for cocktails where all three members 307,308,309 were present, as is evidenced at fulfillment entry 303.

In this illustrative embodiment, the members 307,308,309 have set the obligation manager (101) to track obligations with itemization. Given this configuration, each member entry has an obligation entry 304,305,306 that indicates an obligation due to other members. Due to the members present at each outing, some members 307,309 have obligations due to only one member. Other members 308 have obligations due to multiple members.

Using the obligation register 300 of FIG. 3, determination of fulfillment of a future obligation, in accordance with some embodiments, can be illustrated. Suppose that the three members decide to go to dinner, and one member is going to pick up the tab. If the obligation manager (101) is configured to select the member to fulfill the obligation based upon the largest amount owed, the second member 308 may be selected. If the obligation manager (101) is configured to select on who has paid least recently, the first member 307 may be selected. Other selection processes from this exemplary obligation register 300 will be obvious to those of ordinary skill in the art having the benefit of this disclosure.

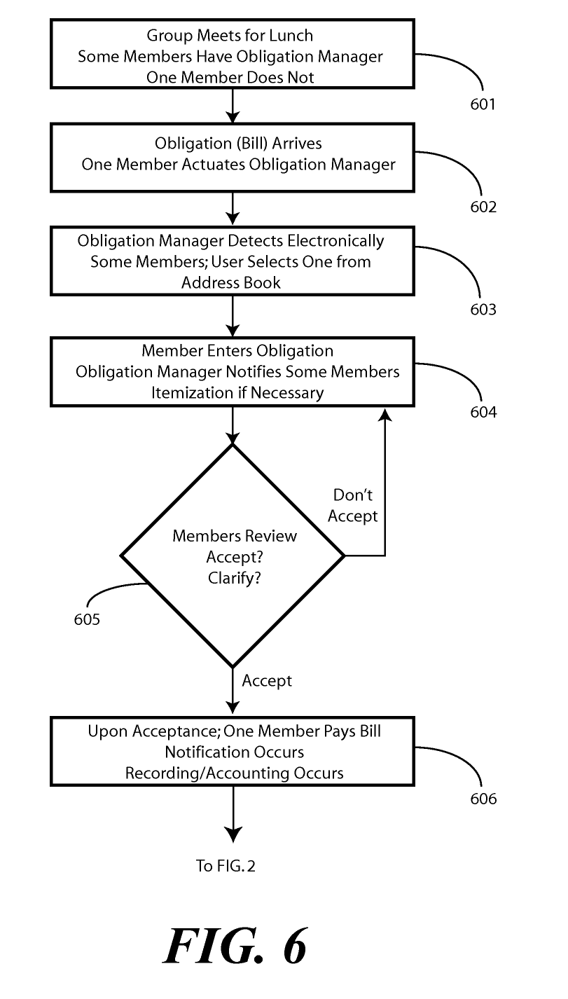

Turning now to FIGS. 5 and 6, illustrated therein is an illustrative use case for embodiments of the invention. FIG. 5 is a schematic block diagram representing members of a group going to lunch. FIG. 6 illustrates a representative flow chart of one embodiment of recordation of fulfillment entries and obligation entries in an obligation register that can occur in accordance with embodiments of the invention. FIGS. 5 and 6 will be referred to collectively in describing the use case.

Each member is represented by a portable communication device 501,502,503,504,505,506 that they carry. These portable communication devices 501,502,503,504,505,506 can communicate with each other either through a network 507, such as with a wireless transceiver, or directly 508 via a local area wireless communication capabilities.

As indicated at step 601, the six members of the group have met for lunch. In this illustrative embodiment, portable communication devices 501,502,503,504, and 505 are equipped with an embodiment of an obligation manager, while portable communication device 506 does not.

As indicated at step 602, the group finishes lunch and the bill 509, which represents the obligation undertaken by the group in this illustration, arrives. While the bill 509 could be transmitted to the obligation manager electronically, in this illustrative embodiment the bill 509 arrives in paper form. The user with portable communication device 501 picks up the bill and launches the obligation manager on his portable communication device 501.

As indicated at step 603, the obligation manager of portable communication device 501 electronically detects the presence of portable communication devices 502,503,504, and 505 by communicating directly 508 with these devices via a wireless local area network communications circuit disposed in each device. As portable electronic device 506 does not include this capability, the user of portable communication device 501 selects this member from an address book stored in portable communication device 501 via its user interface. The members of the group are now identified for the obligation manager of portable communication device 501.

As indicated at step 604, the user of portable communication device 501 enters the amount of the bill into the obligation manager. The user may optionally add in a gratuity amount. Also, the user may optionally itemize the bill for each member as well. The communication module of portable communication device 501 then transmits 510 this information electronically to portable communication devices 502,503,504, and 505. The user of portable communication device 506 can review the information on the display of portable communication device 501.

As indicated at decision 605, the members can accept the data or can request an alternate amount. A member may request an alternate amount due to a typographical error or omission. As indicated at step 606, once the members have all accepted, the user of portable communication device 501 can then fulfill the obligation for the group. The obligation manager of portable communication device 501 then records this fulfillment in its obligation register. Similarly, the obligation managers of portable communication devices 502,503,504, and 505 may enter fulfillment entries, and corresponding obligation entries, in their obligation registers. This data can be used to select the member fulfilling the obligation the next time, as previously described herein.

As illustrated and described, embodiments of the invention can be used for a group that consumes a service, item, or other consumable on a regular basis. When members of the group are out consuming the service or purchasing the items, members of the group can be electronically discovered or manually entered through a user interface. An obligation manager can then suggest which member should fulfill the obligation for the group. The obligation manager can further track obligation fulfillment records in an obligation register.

In the foregoing specification, specific embodiments of the present invention have been described. However, one of ordinary skill in the art appreciates that various modifications and changes can be made without departing from the scope of the present invention as set forth in the claims below. Thus, while preferred embodiments of the invention have been illustrated and described, it is clear that the invention is not so limited. Numerous modifications, changes, variations, substitutions, and equivalents will occur to those skilled in the art without departing from the spirit and scope of the present invention as defined by the following claims. Accordingly, the specification and figures are to be regarded in an illustrative rather than a restrictive sense, and all such modifications are intended to be included within the scope of present invention. The benefits, advantages, solutions to problems, and any element(s) that may cause any benefit, advantage, or solution to occur or become more pronounced are not to be construed as a critical, required, or essential features or elements of any or all the claims.

What is claimed is:

1. A computer readable medium in a portable electronic device having a wireless communication circuit and a user interface, the computer readable medium having instructions stored therein for execution by a processor of the portable electronic device to provide a method for determining which one or more members of a group will fulfill an obligation incurred by the group, comprising:
determining the obligation is due by receiving data through one of the wireless communication circuit or the user interface;
determining the one or more members by comparing the obligation to an obligation register having stored therein an obligation fulfillment history comprising a plurality of past group obligations and identification of members responsible for fulfilling each of the plurality of past group obligations;
notifying the one or more of the members to fulfill the obligation through one or more of the wireless communication circuit or the user interface; and
transforming the obligation register to an updated state by recording the obligation and the one or more members fulfilling the obligation in the obligation fulfillment history.

2. The computer readable medium of claim 1, wherein the recording the obligation comprises recording a fulfillment entry having a fulfillment value associated therewith in the obligation register for each of the one or more members.

3. The computer readable medium of claim 1, further comprising transforming the obligation register by recording an obligation entry for group members other than the one or more members.

4. The computer readable medium of claim 1, further comprising determining what members comprise the group by electronically detecting, with the wireless communication circuit, one or more portable electronic devices located within a local area of the portable electronic device.

5. The computer readable medium of claim 1, further comprising determining what members comprise the group by receiving a user selection from an electronic address book of the members from the user interface.

6. The computer readable medium of claim 1, further comprising receiving a negotiation communication from the one or more members in response to notifying the one or more members to fulfill the obligation.

7. The computer readable medium of claim 1, wherein the obligation comprises one of a billed amount for goods or services received by the group, a quantity and type of goods or services received by the group, or information corresponding to a barter transaction between members of the group.

8. The computer readable medium of claim 1, further comprising clearing obligations owed by a clearing member by notifying the clearing member of a value corresponding to the obligations owed and receiving confirmation of payment of the value.

9. A method in a wireless communication device for determining which one or more members of a group should fulfill an obligation incurred by two or more members of the group, the method comprising:
upon detecting the obligation, accessing an obligation register from a memory device, the obligation register comprising an accounting of at least one member fulfilling at least one past obligation;
selecting the one or more members to fulfill the obligation by comparing the obligation to the obligation register; and
recording fulfillment of the obligation by the one or more members in the obligation register.

10. The method of claim 9, further comprising wirelessly notifying the two or more members of the group that the one or more members will fulfill the obligation.

11. The method of claim 10, further comprising receiving an offer to fulfill the obligation from an offering member, wherein the offering member is not the one or more members.

12. The method of claim 11, further comprising removing the recording of the fulfillment of the obligation by the one or more members in the obligation register and recording another fulfillment of the obligation by the offering member in the obligation register.

13. The method of claim 10, further comprising receiving an acceptance from the one or more members of the fulfillment of the obligation.

14. The method of claim 9, further comprising determining a portion of the obligation attributable to each of the two or more members, wherein the recording the fulfillment of the obligation comprises recording an obligation due corresponding to the portion of the obligation attributable to each of the two or more members for the each of the two or more members.

15. The method of claim 14, further comprising resolving an obligation owed of a member by notifying the member of a value of the obligation owed.

16. The method of claim 9, wherein the comparing the obligation to the obligation register comprises determining recently fulfilling members who have fulfilled recent obligations of the group.

17. The method of claim 9, wherein the comparing the obligation to the obligation register comprises determining one or more members who have obligations due that are greater than obligations due of other members.

18. A wireless communication device, comprising:
a processor and memory operable therewith;
a user interface and a wireless communication circuit, each operable with the processor; and
an obligation manager, operable with the processor and configured to receive notice of an obligation from one of the user interface or the wireless communication circuit, retrieve an obligation register from the memory, the obligation register comprising a plurality of past obligations and members responsible for fulfilling the plurality of past obligations, and determine one or more members to be responsible for the obligation by comparing the obligation to the obligation register; and
a communication module configured to notify the one or more members to fulfill the obligation via one or more of the wireless communication circuit or the user interface.

19. The wireless communication device of claim 18, wherein the obligation manager is further configured to record an obligation due to the one or members by other members by subtracting an amount due by the one or more members from a value owed by the one or more members of the obligation.

20. The wireless communication device of claim 18, further comprising a negotiation module configured to receive one or more offers from the group to fulfill the obligation, where upon receiving an acceptance of the one or more offers, the obligation manager is configured to record one or more accepted offers in the obligation register.
